(19) United States
(12) Patent Application Publication
(10) Pub. No.: US 2024/0317187 A1
(43) Pub. Date: Sep. 26, 2024

(54) APPARATUS, SYSTEM, AND METHOD FOR SENSOR HOUSING

(71) Applicant: TuSimple, Inc., San Diego, CA (US)

(72) Inventors: Qiwei LI, Tucson, AZ (US); Christopher Luis HERNANDEZ, Tucson, AZ (US)

(21) Appl. No.: 18/444,121

(22) Filed: Feb. 16, 2024

Related U.S. Application Data
(60) Provisional application No. 63/491,550, filed on Mar. 22, 2023.

(51) Int. Cl. B60S 1/56; B60S 1/48

(52) U.S. Cl. CPC B60S 1/56; B60S 1/486

(57) ABSTRACT

Provided herein is a system and method for a sensor housing that mitigates glare within the field-of-view and facilitates cleaning of a sensor lens. A sensor assembly may include: a sensor having a sensor lens and a field-of-view through the sensor lens; and a baffle defining a sensor lens aperture, where the field-of-view through the sensor lens is through the sensor lens aperture, where the baffle includes a series of concentric rings extending away from the sensor lens aperture and increasing in diameter as a distance from the sensor lens aperture increases. According to some embodiments, the series of concentric rings defines a viewing angle, where the viewing angle corresponds to the field-of-view of the sensor lens.

### CROSS-REFERENCE TO RELATED APPLICATIONS

This application claims priority to U.S. Provisional Patent Application Ser. No. 63/491,550, filed on Mar. 22, 2023, the contents of which are hereby incorporated by reference in their entirety.

### TECHNOLOGICAL FIELD

An example embodiment of the present disclosure relates generally to the use of sensors having a field-of-view, and more particularly, to an apparatus, system, and method for a sensor housing that mitigates glare within the field-of-view and facilitates cleaning of a sensor lens.

### BACKGROUND

Sensors, such as image sensors, infrared sensors, light sensors, motion sensors, or other sensors having a field-of-view generally receive sensor data from an environment through a lens. These sensors have a wide variety of applicability such as in automation. One form of automation is autonomous and semi-autonomous vehicle control.

Autonomous and semi-autonomous vehicle control relies upon accurate understanding of the environment of a vehicle. A wide array of sensors are often used for autonomous and semi-autonomous vehicle control. Sensors that determine vehicle operating conditions, sensors that determine navigational directions, and sensors that identify the environment around the vehicle.

Maintaining the accuracy and effectiveness of sensors is critical to the proper function of the sensors, and to the information that the sensors provide to the vehicle for operation and for autonomous control. Positioning a sensor is not a trivial challenge, as sensors, particularly sensors relying on line-of-sight from the sensor, benefit from positioning that improves the field-of-view.

Beyond positioning of a sensor, maintaining a sensor in good working condition is imperative for proper functionality. Line-of-sight sensors can become obstructed with dirt, snow, debris, or the like. Stray light or glare can further impact the functionality of such a sensor. Further, positioning a sensor in a highly-visible location to maximize the field-of-view can render the sensors vulnerable to dirt, debris, and objects such as bugs that can obstruct the field-of-view.

### BRIEF SUMMARY

An apparatus, system, and method are therefore provided for sensor operation for sensors having a field-of-view, and more particularly, to sensor housings that mitigate glare within a field-of-view of the sensor and facilitates cleaning of a lens of the sensor. Embodiments provided herein include a sensor assembly including: a sensor having a sensor lens and a field-of-view through the sensor lens; and a baffle defining a sensor lens aperture, where the field-of-view through the sensor lens is through the sensor lens aperture, where the baffle includes a series of concentric rings extending away from the sensor lens aperture and increasing in diameter as a distance from the sensor lens aperture increases. According to some embodiments, the series of concentric rings defines a viewing angle, where the viewing angle corresponds to the field-of-view of the sensor lens. According to certain embodiments, the series of concentric rings include forward-facing surfaces between surfaces that are substantially parallel to an axis through a center of the sensor lens.

According to some embodiments, the surfaces that are substantially parallel to the axis through the center of the sensor lens have a surface texture configured to diffuse light. According to certain embodiments, the sensor assembly includes an injector, where the injector is received within a port of the baffle and configured to direct a spray pattern of cleaning fluid toward the sensor lens. The injector of an example embodiment is controlled by a controller, where the controller commands the injector to spray the sensor lens with the cleaning fluid. The controller of an example embodiment is configured to establish a cleaning regimen based, at least in part, on environmental context of the sensor assembly.

According to some embodiments, the cleaning regimen is further based, at least in part, on at least one of time of travel of a vehicle associated with the sensor assembly or distance of travel of the vehicle associated with the sensor assembly. The sensor assembly of some embodiments further includes a pneumatic nozzle, where the pneumatic nozzle is configured to direct a burst of air to the sensor lens of the sensor assembly. The pneumatic nozzle of an example embodiment is controlled by the controller, where the controller commands the nozzle to direct the burst of air to the sensor lens of the sensor assembly. According to some embodiments, the nozzle is supplied with a cleaning fluid for cleaning of the sensor lens, where the nozzle is configured to direct a spray pattern of the cleaning fluid toward the sensor lens of the sensor.

Embodiments provided herein include a baffle for a sensor assembly including: a sensor lens aperture for receiving therein a sensor lens of the sensor assembly; a series of concentric rings extending away from the sensor lens aperture and increasing in diameter as a distance from the sensor lens aperture increases, and a nozzle defined within the baffle, where the nozzle is configured to direct a spray pattern of cleaning fluid toward a sensor lens received in the sensor lens aperture. According to some embodiments, the nozzle is supplied with fluid from an injector where the baffle defines a port into which the injector is received. The series of concentric rings of an example embodiment defines a viewing angle, where the viewing angle corresponds to a field-of-view of the sensor lens, where the series of concentric rings include forward-facing surfaces between surfaces that are substantially parallel to an axis through a center of the sensor lens. The surfaces that are substantially parallel to the axis through the center of the sensor lens have, in some embodiments, a matte finish surface texture.

Embodiments provided herein include a method for protecting and cleaning a lens of a sensor assembly including: surrounding the lens of the sensor assembly with a baffle, where the baffle defines a sensor lens aperture, and where the baffle includes a series of concentric rings extending away from the sensor lens aperture and increasing in diameter as a distance from the sensor lens aperture increases. According to some embodiments, the method includes cleaning the lens of the sensor assembly with a spray pattern of cleaning fluid, where the spray pattern emanates from a nozzle disposed within the baffle. The method of some embodiments includes controlling the cleaning of the sensor assembly using a controller, where the controller commands the cleaning of the lens. The method of some embodiments further includes establishing a cleaning regimen for the sensor based, at least in part, on environmental context of the sensor assembly. The cleaning regimen of some embodiments is further based on at least one of time of travel of a vehicle associated with the sensor assembly or distance of travel of the vehicle associated with the sensor assembly.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 illustrates a top-view of a vehicle including a sensor assembly according to an example embodiment of the present disclosure;

FIG. 2 illustrates a side-view of the vehicle including a sensor assembly according to an example embodiment of the present disclosure;

FIG. 3 illustrates a frontal view of a sensor assembly according to an example embodiment of the present disclosure;

FIG. 4 illustrates a rear view of a sensor assembly according to an example embodiment of the present disclosure;

FIG. 5 illustrates a side section view of a sensor baffle according to an example embodiment of the present disclosure;

FIG. 6 illustrates a front-view and a cross-section view of a sensor baffle according to an example embodiment of the present disclosure;

FIG. 7 illustrates three cross-section views of sensor baffles having different ranges and fields-of-view according to an example embodiment of the present disclosure;

FIG. 8 illustrates a cross-section view of a sensor baffle incorporating an injector for cleaning of the sensor lens according to an example embodiment of the present disclosure;

FIG. 9 illustrates a cross-section view of a sensor baffle incorporating a nozzle for cleaning of the sensor lens according to an example embodiment of the present disclosure; and

FIG. 10 illustrates a rear view of a sensor baffle incorporating a nozzle for cleaning fluid and a pneumatic nozzle for cleaning a lens of a sensor assembly according to an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

While embodiments described herein generally reference sensors for autonomous vehicle operation; however, embodiments described herein can be employed for sensors in a variety of use cases. For example, embodiments may be employed for sensors on non-autonomous vehicles, watercraft, aircraft, construction equipment, utility vehicles, etc. As such, embodiments described herein are not intended to limit the use case, but instead demonstrate the utility of embodiments in a specific use case.

Autonomous vehicle control, as described herein, includes vehicle control that is performed at least partially by a vehicle controller taking some responsibilities away from a human driver. Autonomous vehicle control can include semi-autonomous control, where certain functions are performed by a controller, while a human driver performs other functions, and fully-autonomous control, where a human driver is not necessary for control and navigation of the vehicle. Autonomous vehicle control, as described herein, includes this array of control possibilities such that the term “autonomous vehicle control” can include any degree of autonomous control ranging from minimal autonomy to fully autonomous.

Autonomous vehicle control is becoming more widely adopted, with increasing levels of autonomy becoming practical. Autonomous vehicle control is particularly beneficial for transport of goods, where such transport can occur at all hours of the day and for long distances. Although the systems and methods of example embodiments may be employed in conjunction with a variety of different types of autonomous vehicles, the systems and methods described herein will be described in conjunction with a truck, such as a tractor trailer, that is configured to operate autonomously by way of example, but not of limitation.

Vehicle sensors are often critical for operation of the vehicle. Sensors of conventional, manually-driven vehicles perform a wide range of functions, from wheel speed sensors, to rain detecting sensors, to parking sensors. Vehicles that have some degree of autonomy, whether it is adaptive cruise control, braking assist, steering assist, or total driverless autonomous control, require additional sensors, and many of these sensors are critical to the autonomous functionality of the vehicle. Sensor failures in vehicles can impair vehicle function, and when those sensors are critical to autonomous control, such sensor failure can require autonomous control to be relinquished to a human driver. It is critical to maintain vehicle sensor functionality. While certain sensors can function in a capacity-reduced state, other sensors are more sensitive to environmental conditions and adverse effects. Embodiments described herein provide an apparatus, system, and method for a sensor housing that mitigates glare within the field-of-view and facilitates cleaning of a sensor lens to maintain optimal functionality.

While sensor positioning and functionality is important for all autonomous vehicles, it is particularly important for large vehicles. Roadways with traffic, urban corridors, and narrow streets or rural roads pose a greater challenge to large vehicles as there is less room for error in movement to avoid contact between the large vehicle and any elements of the environment. As such, positioning of certain sensors on a large vehicle is important to optimize functionality.

Sensors that require line-of-sight are particularly sensitive to position as they function best with a clear, broad range of vision. Cameras, radar, and infrared sensors are examples of such line-of-sight sensors that benefit from optimized positions. While embodiments of the systems and methods described herein for sensor housing and cleaning can be implemented with any of these line-of-sight reliant sensors, embodiments of the illustrated embodiment will herein be referenced with regard to an image or infrared sensor that can be used to facilitate autonomous vehicle control.

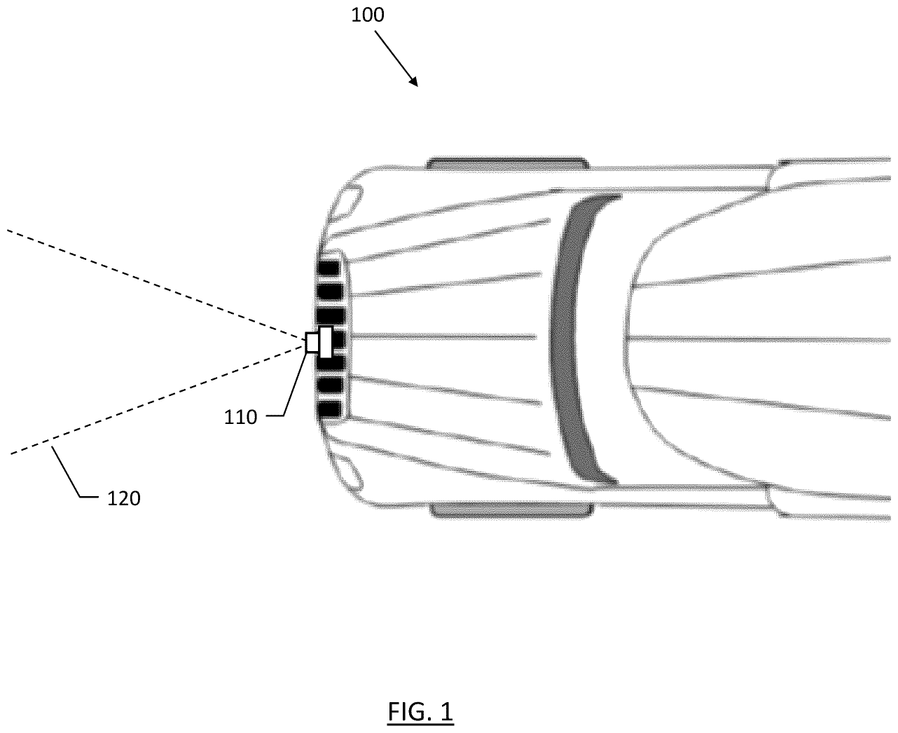

FIG. 1 illustrates the forward portion of a truck 100 having a sensor assembly 110 positioned strategically on the front end of the truck with a sensor field-of-view 120 depicted in dashed lines. The illustrated embodiment depicts a single sensor assembly 110; however, in many cases, several sensor assemblies may be employed in different positions having different fields-of-view. Optionally, multiple sensors can be employed in a single sensor assembly having multiple fields-of-view. While the sensor assembly 110 location of FIG. 1 is at the front end of a truck with a forward-facing field-of-view, the sensor assembly mounting locations are purposefully selected, and sensor assemblies can be mounted in a variety of locations including any number sensors to obtain a comprehensive view of the surroundings of the vehicle. Sensor positioning is generally forward-biased (toward the front of the vehicle) as the primary direction of travel of the vehicle, particularly when using the sensors for autonomous control, is in the forward direction. Thus, the positioning of the sensor assembly shown in FIG. 1 is well-suited to autonomous vehicle control in the forward direction. Additional sensors may be required for autonomous control in the reverse direction such that the field-of-view behind the vehicle is covered.

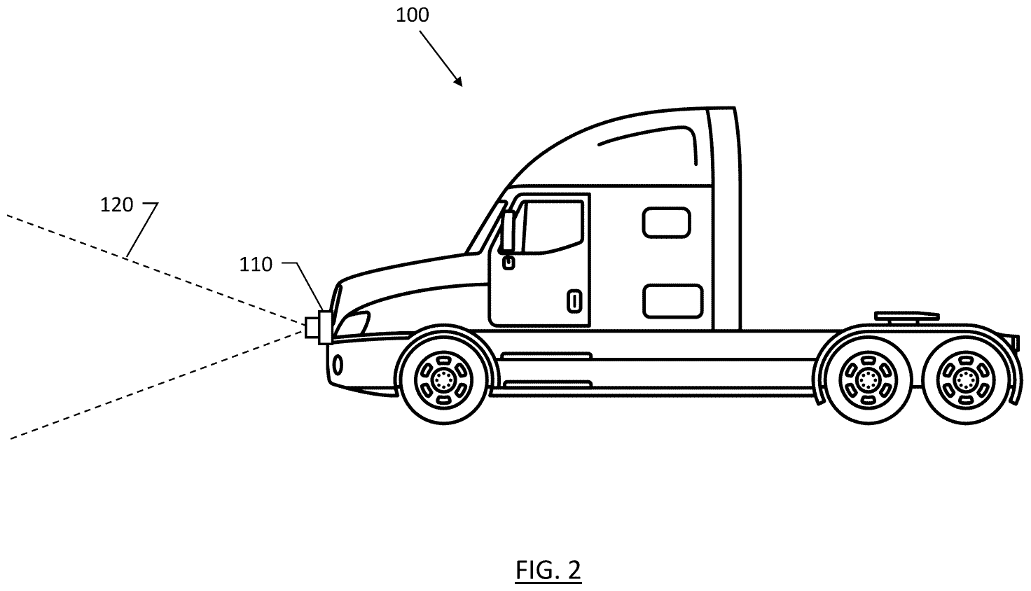

FIG. 2 illustrates a left-side view of the truck 100 of FIG. 1 including the sensor assembly 110 mounted at the front end of the truck 100. The size and position of the sensor assembly 110 is not exact and is depicted for illustrative purposes. The sensor assembly of an example embodiment may be recessed within a portion of the truck, such as within a grill forward of a radiator of the truck 100.

The sensor assembly 110 can be mounted in a variety of ways, whether prominently exposed or recessed within a portion of the vehicle. The sensor assembly 110 is generally rigidly mounted to the vehicle to be securely maintained in a consistent position. The sensor assembly of an example embodiment can be in electronic communication with a controller (not shown). The controller is configured to operate the sensor of the sensor assembly and to control data capture and processing. The controller may be in wired or wireless communication with the sensor.

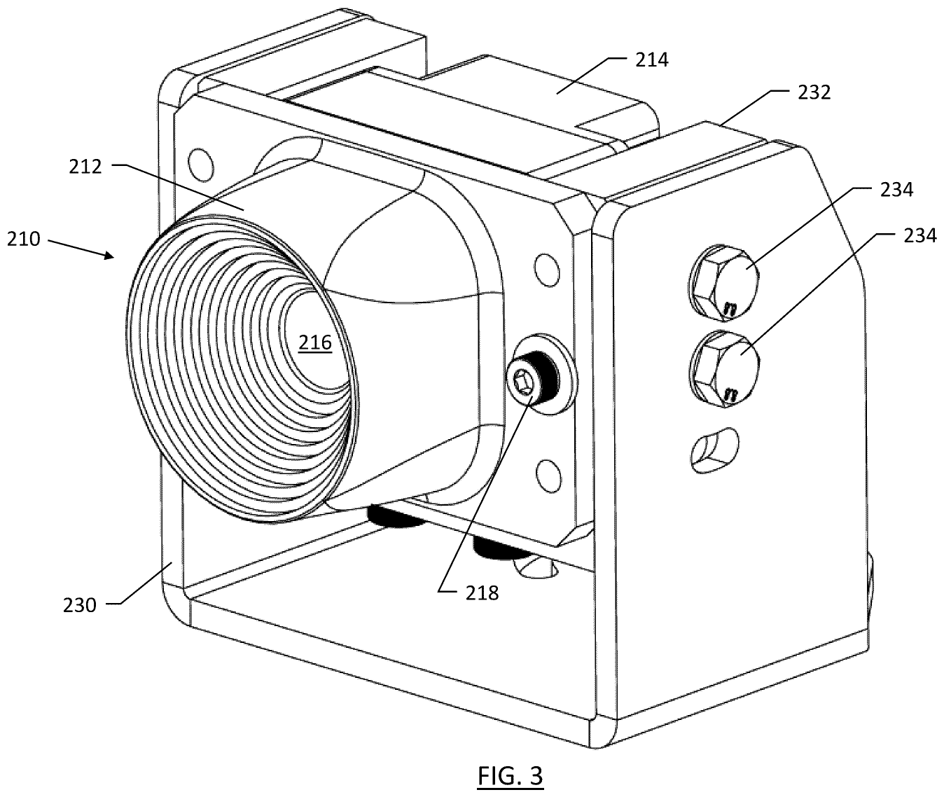

FIG. 3 illustrates an example embodiment of a sensor assembly 210 supported by a mounting bracket 230. The sensor assembly 210 includes a baffle 212 secured to the sensor body 214 and surrounding a lens 216 of the sensor. The bracket 230 includes a mounting block 232 which is secured to the bracket 230 on either side by fasteners 234. The baffle 212 is secured to the mounting block 232 by fasteners 234.

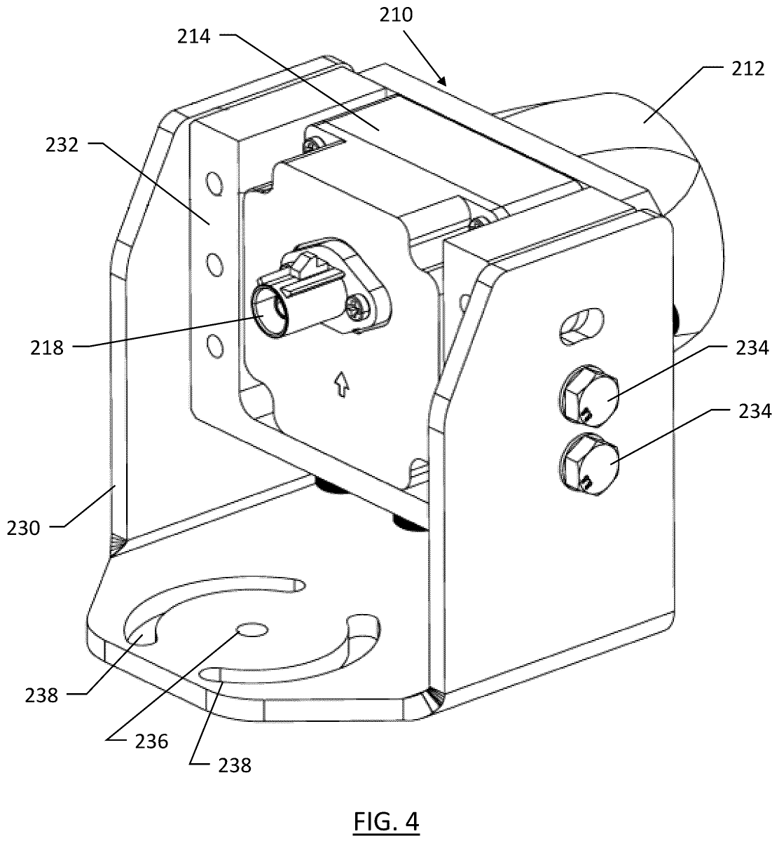

FIG. 4 illustrates a back view of the sensor assembly 210 of FIG. 3 including the mounting bracket 230. As shown, the sensor body 214 includes a connector 218. The connector 218 is configured to support a wired connection to the sensor body 214, such as a connection to the controller which facilitates operation and sensor data collection from the sensor assembly 210. Also shown is a fastener hole 236 and channels 238 of the bracket 230. The fastener hole 236 is configured to be used to secure the bracket 230 to a surface with a fastener through the fastener hole. The channels 238 are arcuate such that a fastener received through one or each of the channels can allow adjustable rotation about an axis of the fastener through fastener hole 236 before the fasteners are tightened to secure the bracket 230 to the surface to which it is mounted. This adjustability allows for aiming of the sensor assembly 210 to be properly directed for the necessary sensor data collection.

As shown in the illustrated embodiments of FIGS. 3 and 4, the sensor assembly includes a baffle 212 which is secured to the mounting block 232 by fasteners 234. The baffle surrounds a lens 216 of the sensor. According to some embodiments, the baffle 212 is secured to the sensor body 214 in a manner to preclude contaminants from coming between the baffle and the sensor body. A gasket or seal may be employed to ensure secure contact between the sensor body 214 and the baffle 212. The baffle 212 is employed to protect the lens 216 and to mitigate environmental noise from entering the sensor through the lens by shielding the lens while not impeding the field-of-view of the sensor. The sensors of example embodiments may have different fields of view as described further below.

While the baffle 212 can shield and protect the sensor lens 216 from noise that may otherwise enter the sensor lens through a path outside of the field-of-view of the sensor, the sensor is necessarily vulnerable to sensor noise within the field of view. As the sensor of example embodiment relies upon line-of-sight within the field-of-view, it is important to keep the field-of-view free of obstructions for sensor performance. The baffle 212 is configured with a shape commensurate with a field-of-view. In the illustrated embodiment, that field-of-view is generally conical in shape; however, embodiments could employ other field-of-view shapes with baffles shaped accordingly. While the field-of-view remains free of obstruction, the baffle can potentially permit off-axis noise entering the sensor lens.

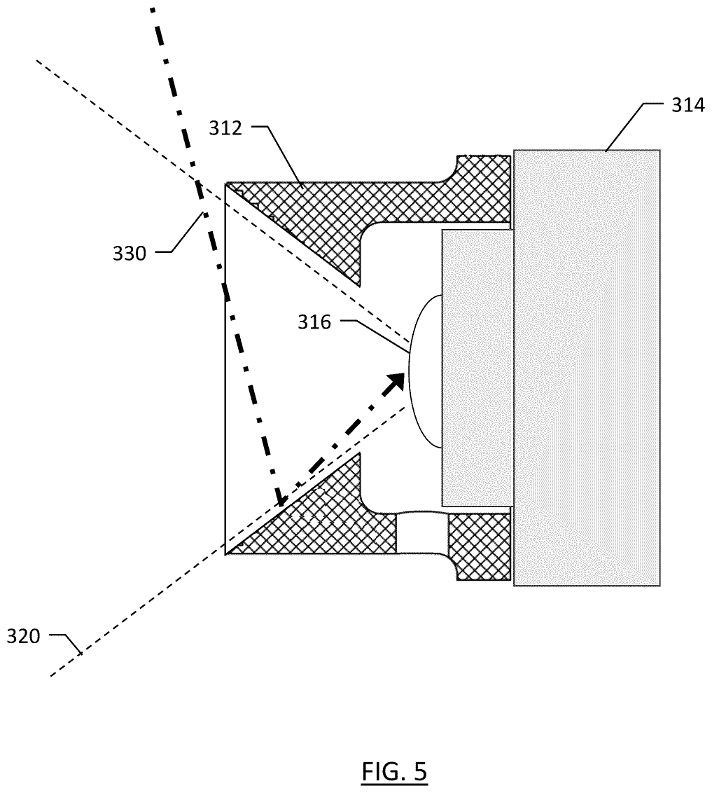

FIG. 5 illustrates an example embodiment of a baffle 312 of the prior art that surrounds lens 316 of sensor body 314. As illustrated, the sensor includes a field-of-view 320 illustrated by dashed lines. The baffle allows sensor data to be collected within the field-of-view while mitigating some off-axis noise. However, as illustrated by noise 330, the baffle 312 can inadvertently facilitate off-axis noise reaching the sensor lens 316. This off-axis noise can be detrimental to the sensor and can adversely impact sensor data collected. Off-axis noise can include glare, such as where the off-axis noise is light from an external source that is reflected into lens 316. This light can impact the sensitivity of the sensor which can reduce a quality of sensor data gathered from the field-of-view.

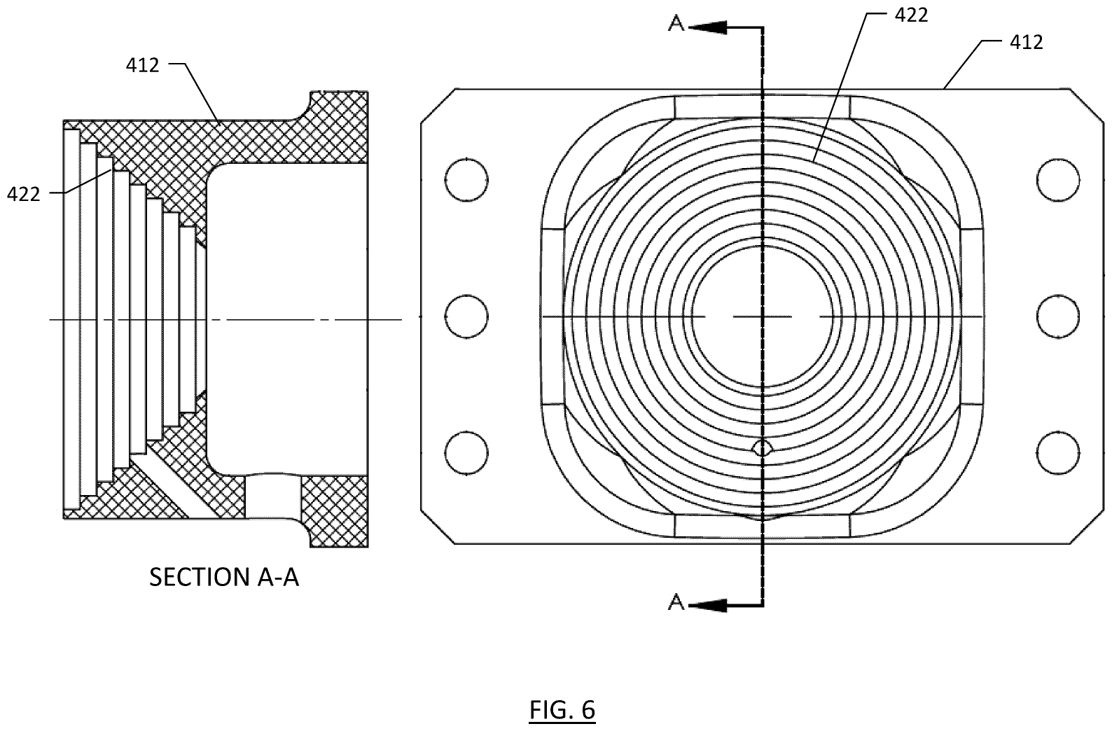

Embodiments of the present disclosure includes a sensor baffle that includes a structure that mitigates off-axis noise. FIG. 6 illustrates a front-view of baffle 412 with section line A-A and section view taken along section line A-A. As shown in the illustrated embodiment, the baffle 412 includes a series of concentric rings 422 that form a stair-step surface surrounding the field-of-view aperture of the baffle. This surface reduces the likelihood of off-axis noise entering the sensor through the sensor lens in two ways. The stair-step surface breaks up the surface of the field-of-view aperture such that if off-axis noise is received within the field-of-view aperture, the noise is reflected at different angles. Further, the stair-step surface includes forward-facing surfaces that reflect off-axis noise away from the sensor lens. The surfaces that extend between the forward-facing surfaces are substantially parallel to an axis through the center of the sensor lens, which are less likely to reflect off-axis noise into the sensor lens. Substantially parallel, as described herein, are within ten degrees of parallel, for example.

The series of concentric rings 422 increases in diameter as a distance from the sensor lens aperture increases. Further, the increase in diameter for the series of concentric rings defines a viewing angle, where the viewing angle defined through the series of concentric rings corresponds to a field-of-view of a sensor attached to the baffle. The forward-facing surfaces of the series of concentric rings can have a variety of surface textures without adversely impacting sensor data received at the lens. However, the surfaces that extend between the forward-facing surfaces that are generally parallel to an axis through the center of the sensor lens generally include a surface texture that has a tendency to poorly reflect light. For example, the surface can be a matte finish surface or a rough textured surface that does not reflect light as much as it diffuses light that reaches the surface.

The field-of-view aperture surface of the illustrated embodiment reduces off-axis noise, but also reduces the likelihood that debris entering the baffle through the aperture would reach the sensor lens. The sensor assembly of embodiments described herein can be used to facilitate autonomous vehicle control. In doing so, the sensor assembly may be directed in the direction of travel of the vehicle, subjecting the sensor assembly to wind, precipitation, debris, etc. as the vehicle proceeds in the direction of travel. The field-of-view aperture surface of the embodiment of FIG. 5, having a relatively smooth surface, may function as a funnel with precipitation and debris (e.g., dirt, dust, bugs, etc.) being guided to the lens surface by the smooth surface. Such precipitation and debris can adversely impact collected sensor data as it obstructs the sensor lens.

The stair-step surface of the field-of-view aperture of the embodiment of FIG. 6 mitigates the issue of precipitation and debris reaching the lens by virtue of the forward-facing surface of the stair-step surface. Precipitation and debris that impacts the stair-step surface is not guided or funneled toward the lens, but rather stopped or slowed by impacting a surface perpendicular to the direction of travel. This functionality of the stair-step surface of the field-of-view aperture can reduce the volume of precipitation and debris reaching the lens, thereby improving the quality of sensor data gathered by the sensor assembly while proceeding in a direction of travel of a vehicle.

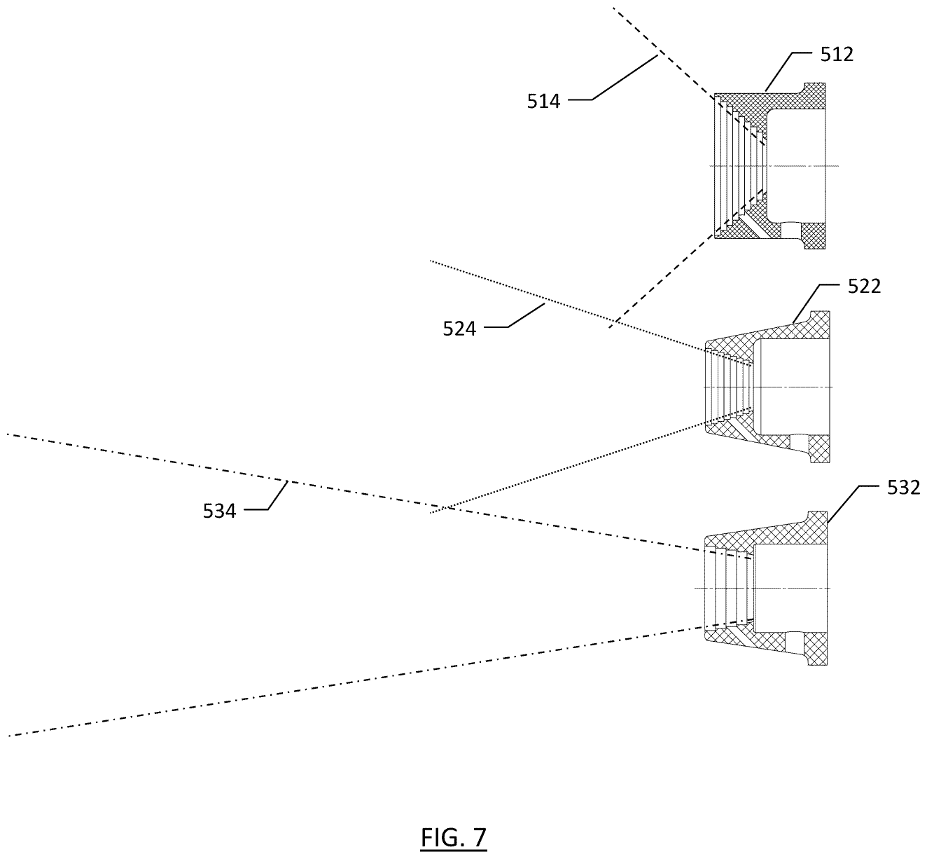

The baffles of example embodiments described herein can facilitate sensor data collection with sensors having different fields-of-view. FIG. 7 illustrates three example embodiments of baffles having different fields-of-view. As shown, a first baffle 512 is shown in cross-section with first field-of-view 514. The wide field-of-view of the first baffle 512 is configured for a short-range sensor detecting a wide area proximate to the sensor. A second baffle 522 is shown in cross-section having a second field-of-view 524. The second baffle 522 is configured for a mid-range sensor detecting an area further away than the short-range sensor, but having a narrower field-of-view. A third baffle 532 is shown in cross-section having a third field-of-view 534 which is still narrower. The third baffle 532 is well-suited to a long-range sensor.

As noted above, sensors of example embodiments described herein may be mounted in such a way as to be directed in the direction of travel of a vehicle. This configuration is susceptible to debris accumulation on the sensor lens. Debris can be in the form of dirt, dust, bugs, water, or any object that collects on the sensor lens and adversely impacts sensor performance. Degradation in sensor performance can compromise the abilities of a vehicle. Autonomous vehicle control relies upon sensor data to help safely navigate within a road network. If one or more of the sensors of an autonomous vehicle are not properly functioning, autonomous vehicle control may not be available. This can lead to vehicle operator dissatisfaction as the vehicle may require manual control. Further, safety may be compromised when sensor functionality is degraded.

Embodiments described herein provide a mechanism by which the lens of a sensor can be cleaned to aid in maintaining full functionality of the sensor and improving the autonomous capabilities of a vehicle associated with the sensor. Cleaning of a sensor lens may not be possible using conventional automotive means such as wipers (e.g., windshield wipers). The size and position of sensors described herein are not well-suited for windshield-style wipers. Further, the complexity of moving parts is less than ideal for a lens cleaning system.

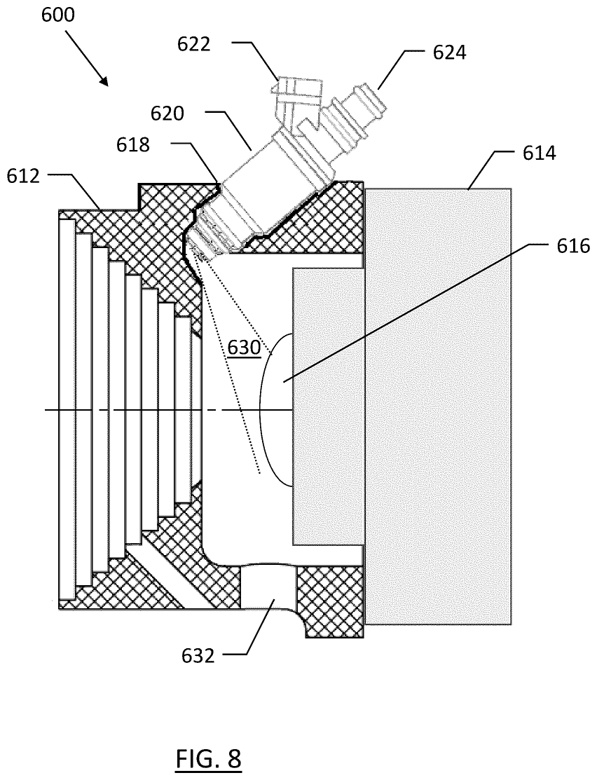

FIG. 8 illustrates an example embodiment of a sensor baffle 612 described herein employing a cleaning system for cleaning of debris from a lens 616 of the sensor assembly 600. The baffle 612 of the illustrated embodiment includes a port 618 into which an injector 620 is received. The injector 620 is configured to spray a fluid in a spray pattern 630, where the spray pattern impinges upon the lens 616. The injector 620 can be used for a variety of liquids, such as water, methanol, ethylene glycol, or the like. The injector may be configured to operate at a high pressure, such as 30 psi (pounds per square inch) to 70 psi. Such high pressures can be used to drive debris from the lens 616 surface.

The injector can be an injector similar to those used for fuel injection; however, the fluid used in the injector is a cleaning fluid rather than fuel. The injector can include a fluid inlet 624 through which fluid is received under pressure, while electrical connector 622 is used to control the cleaning fluid operation. The injector can include a nozzle that generates the spray pattern 630 for cleaning the lens 616 of the sensor. Optionally, the baffle 612 may be configured with a nozzle. According to an example embodiment in which the baffle 612 provides the nozzle, the injector 620 may be received within port 618. An outlet of the injector can be an inlet to the nozzle, such that operation of the cleaning fluid injector causes the fluid to be driven from the injector outlet, through the nozzle of the baffle 612, and into spray pattern 630 to the lens 616. Incorporating the nozzle into the baffle can be beneficial as such a nozzle would not be affected by an orientation of the fluid injector 620 rotationally within the port 618. The baffle 612 further includes a drain 632 that enables the cleaning fluid to drain from the baffle and carry with it debris rather than accumulating within the baffle.

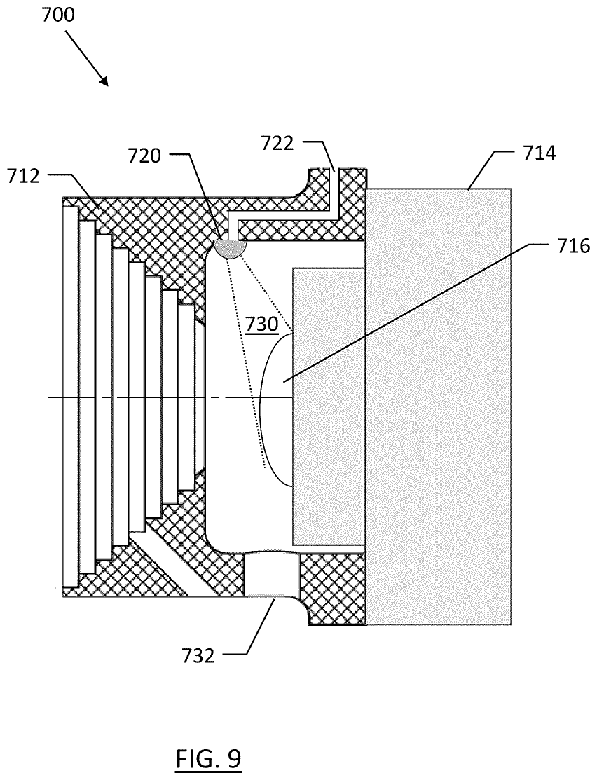

While a fluid injector is illustrated in FIG. 8, embodiments can employ a cleaning fluid hose and nozzle within the baffle. FIG. 9 illustrates an example embodiment of a baffle 712 of a sensor assembly 700 in which the cleaning is facilitated by a cleaning nozzle 720. The baffle 712 may define therein a fluid passage 722 that is fed by a fluid source (e.g., a fluid pump) located externally of the sensor assembly 700. The embodiment of FIG. 9 (and possibly FIG. 8) may optionally be plumbed together with a windshield washing fluid reservoir and supplied by the same fluid pump. This may be of particular benefit as a vehicle would not require a separate cleaning fluid tank to supply the cleaning of the sensor lens 716. Further, the cleaning could optionally be triggered in the same manner as the windshield washer fluid for the windshield. As the sensor lens 716 and the windshield are facing the same direction, a level of contamination of the windshield may be a good indicator of the level of contamination of the sensor lens 716. Thus, the actuation of the windshield washer fluid for the windshield may correspond to actuation of the cleaning system of the sensor assembly 700. The spray pattern 730 of the nozzle 720 may cover the sensor lens 716 as with the embodiment of FIG. 8. The drain 732 of the embodiment of FIG. 9 functions similarly to drain the cleaning fluid from the baffle 712 and carry with it any debris that has accumulated on the lens.

While the embodiment of FIG. 9 is described with respect to actuation with the windshield washer cleaning of the windshield, embodiments described herein can have separate actuation for cleaning of the sensor lens. One such trigger configured to actuate the cleaning of the sensor lens 716 can include a controller configured to identify a degradation of the sensor data received from the sensor assembly 700. A controller can detect the signals from the sensor collected through the sensor lens and establish a degradation of the sensor data, such as sensor data having areas omitted, less sharp edges, or object detection from sensor data becomes less reliable. When such sensor data degradation is detected, the sensor cleaning system may activate to spray cleaning fluid on the sensor lens and clean the debris from the lens to restore sensor performance.

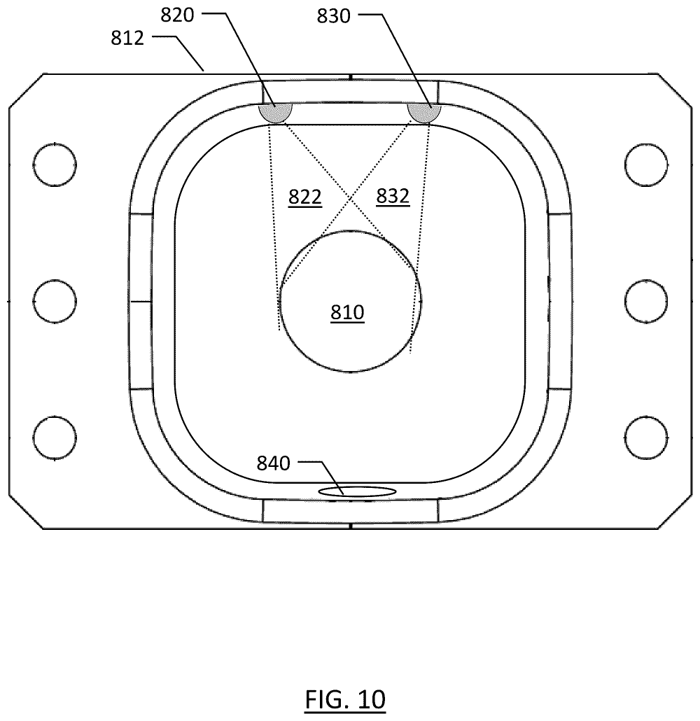

According to some embodiments, the sensor cleaning system may optionally include a pneumatic cleaning and/or drying operation. A pneumatic nozzle may be employed within the baffle of some embodiments to blow debris off of a lens and to dry a lens that has been sprayed by a cleaning fluid, or has been exposed to precipitation. FIG. 10 illustrates a back-view of an example embodiment of a baffle 812 for a sensor as described herein. The aperture 810 of the baffle 812 approximates the size of the lens of a sensor of an example embodiment. The sensor body has been omitted for ease of understanding. As shown, the baffle includes two nozzles, including a fluid nozzle 820 and an air nozzle 830. The fluid nozzle 820 can be embodied as an injector as described above, and may be formed in the baffle in some embodiments. The spray pattern 822 of the fluid nozzle 820 is configured to substantially cover the lend while cleaning the lens.

The air nozzle 830 of FIG. 10 is depicted as having an air stream pattern 832 substantially covering the lens when activated. The air nozzle may be embodied in a manner similar to the fluid nozzle. For example, the air nozzle can be an air injector similar to fluid injector 620 described above. Optionally, the air nozzle can be formed within the baffle and supplied by a pneumatic source. Further, the nozzle may be a separate nozzle installed within the baffle and supplied by a pneumatic source. The air nozzle may direct the air stream pattern 832 after cleaning fluid has been sprayed on the lens to dry the lens of the cleaning fluid and to dislodge any additional debris. Similarly, if the sensor is operating in a wet environment (e.g., active precipitation and/or water spray from a road surface), the air nozzle may be configured to dry the lens of the sensor assembly without use of cleaning fluid.

The air nozzle 830 of example embodiments described herein can further be employed to blow debris from the baffle 812. In this manner, the air nozzle may have an air stream that is directed toward the drain 840 of the baffle. Such a configuration may enable loose debris to be blown and driven from the baffle 812 to remove the debris and prevent the debris from redepositing on the sensor lens. The air nozzle of example embodiments may be operated in a manner similar to that of the fluid nozzle. A controller may be configured to control operation of the air nozzle. In some embodiments, the air nozzle may be actuated following actuation of the fluid nozzle or injector. This may be an operation that is commanded in sequence by the controller without separate activation required.

The air nozzle may be supplied by a pneumatic pump or supplied by an air tank or reservoir configured to retain air at a predetermined pressure, which may be supplied by an air pump or siphoned from an engine or motor. Commercial trucks often employ the use of pneumatic brake systems, such that air may be supplied for cleaning and drying of the lens from this pneumatic system. Such multiplexing of existing systems reduces complexity and cost associated with implementing embodiments described herein.

The nozzles may be formed of separate elements that are pressed or secured to the baffle. The nozzles may be press-fit into the baffle or secured using mechanical means, such as set screws, or through chemical means, such as using an adhesive or solvent. The nozzles of some embodiments may be formed with the baffle such that they are not separate pieces. For example, the nozzles may be molded in place for an injection molded baffle or printed in place for a three-dimensionally printed baffle. Still further, the nozzle bodies may be integrally formed with the baffle, such that a nozzle orifice is separately inserted into the nozzle bodies to form the appropriate spray pattern. In such an embodiment where nozzle bodies are formed with the baffle and nozzle orifices are separately installed, the nozzle orifices may be selected based on a spray pattern that corresponds with the specific sensor that is to be used with the baffle. A fine, higher pressure spray pattern may be beneficial for a sensor with a compact sensor window that is sensitive to small pieces of debris. A broad, lower pressure spray pattern may be beneficial for a sensor with a wider window that is less sensitive to small pieces of debris.

According to some embodiments, a single nozzle or injector may be employed for both cleaning fluid and air delivery to the sensor lens. Such a nozzle may be provided with both a cleaning fluid supply and an air supply, both at pressure, to be directed toward the lens. A switching valve within the nozzle or injector can be used to switch between air and cleaning fluid. According to some embodiments, the cleaning fluid spray and the air spray may be sequential and timed to achieve optimum cleaning of the lens.

While embodiments described above employ a cleaning fluid and/or a pneumatic stream of air to facilitate cleaning of a sensor lens, embodiments may optionally employ an abrasive slurry to clean the sensor lens of stubborn debris. A slurry such as a silica enhanced liquid may be used to provide an abrasive to the sensor lens which is able to remove debris that may be dried onto the lens or mineral deposits that have adhered to the lens, such as salt spray residue. The abrasive selected may be selected from a group of abrasives that have a hardness substantially lower than the hardness of a sensor lens such that the abrasives do not risk scratching the sensor lens in the process of cleaning.

A baffle for a sensor assembly as described herein can optionally be heated to reduce or eliminate ice formation and accumulation proximate the sensor. The baffle may include a resistive heating element attached thereto or embedded therein. The heating element can heat the baffle in such a way that any ice accumulated within the baffle or on the sensor will melt to avoid obstructing the sensor lens. Ice can accumulate within the sensor baffle through precipitation that freezes on the baffle and sensor, or snow accumulation, for example. Embodiments of a heated baffle may employ a heater control to perform heating cycles during operation of the senor. For example, the baffle may be heated periodically when a temperature of an environment of the sensor is below a predetermined temperature. Accumulated snow and ice, as it melts, can drain through the drain hole of example embodiments described above.

The baffle of example embodiments described herein can be formed from a variety of materials using a variety of manufacturing techniques. For example, the baffle may be made of a plastic or resin material which may be formed through molding (e.g., injection molding, etc.), three-dimensional printing, or the like. The baffle of some embodiments may be formed of a fiber-reinforced material, such as fiberglass or carbon fiber. The baffle may optionally be machined for precision, where the baffle may be machined from a solid block of material, or machined from a molded part to remove surface imperfections and to improve dimensional accuracy. Embodiments can optionally be formed of a metal, such as aluminum or magnesium. Such embodiments may be formed through casting, molding, machining, etc. According to some embodiments, the baffle may be formed from multiple parts. For example, the stair-step surface may be made from a first material using a first manufacturing method, while the body of the baffle may be made using a different material and different manufacturing method. The dimensional constraints on different parts of the baffle may be suited to different manufacturing methods. Further, the port into which the nozzle or injector is received may be formed from another material, such as using an insert that is specifically formed to accept an injector or nozzle securely without leakage. A baffle of an example embodiment may be formed within a mold into which an injector port or nozzle port is held such that the baffle is formed about the port, thereby maintaining dimensional accuracy of the port for benefit of sealing of the nozzle or injector.

For a heated embodiment of the baffle described herein, the heating element may be formed on a surface of the baffle after formation of the baffle, or embedded into the baffle during molding. A resistive heating element, such as a nichrome wire, can be embedded within a mold and the baffle molded around the heating element. A lead from the heating element can extend outside of the baffle to be connected to a current supply. The current may be supplied through the same connector as for the sensor described above.

The sensor assembly of embodiments described herein is wired or wireless communication to a control system of a vehicle. The control system can be a sensor-specific controller, or a module of the vehicle, for example. The sensor assembly can transmit data collected by the sensor to a controller that parses the sensor data to aid in vehicle navigation, autonomous vehicle function, and data collection regarding an environment of the vehicle. The data transmitted by the sensor to the controller can further include an indication of a condition of the sensor. For example, if the sensor is fouled, such as by dirt, bugs, liquid, or the like, the sensor data can indicate that the sensor function may be degraded and that the sensor requires cleaning. This indication can be used to inform the cleaning system described herein, prompting cleaning nozzles to be actuated until sensor function is properly restored. If after cleaning nozzles have actuated for a predetermined time the sensor function is still communicated to be degraded, manual inspection may be prompted, such as via a user interface of the vehicle.

Components of the sensor cleaning system described herein can provide feedback on an adequacy of sensor cleaning based on sensor data captured by the sensor. In the event that sensor performance remains degraded after a cleaning cycle, additional cleaning cycles may be prompted. Optionally, in an embodiment with a variable speed pump, a pressure of cleaning fluid through the nozzles may be increased to provide additional cleaning to obtain optimum sensor performance.

The sensor cleaning operation may be performed periodically without requiring feedback from the sensor itself as periodic cleaning may be established as a preventative mechanism to maintain sensor performance. According to some embodiments, the periodic cleaning of the sensor may be a learned period that considers environmental factors, climate, and use patterns. For example, a vehicle that regularly traverses dirt or gravel roads may be exposed to copious amounts of airborne dust that can accumulate on a sensor. Vehicles such as construction vehicles, agricultural vehicles, or even vehicles that routinely visit unimproved properties or gravel and dirt roads may also encounter airborne debris or particulates which could occlude a sensor field of view. For the roads traversed by autonomously controlled vehicles, the type or condition of the roads can be established based on map data that is readily available to the autonomously controlled vehicles. Further, the geographic region of a vehicle may be considered when establishing periodic cleaning schedule. Vehicles that regularly travel in colder climates in the winter months may be exposed to road surfaces that are covered with salt or brine solution. Those vehicles will experience greater amounts of airborne salt water vapors that can accumulate on a sensor lens and degrade performance. The period for cleaning of sensor lenses in such environments may be high. Thus, the controller of a vehicle may use contextual clues of an environment of a vehicle to establish a cleaning regimen for the sensor lens using embodiments of the sensor assembly described herein.

In addition to or in lieu of periodic sensor cleaning, the sensor cleaning can be based on a distance traveled for a vehicle. The sensor cleaning operation may be performed at a predetermined mileage interval. Optionally, the mileage interval may be modified based on the environmental contextual factors described above. According to some embodiments, sensor cleaning may occur when a vehicle begins to travel (e.g., when a vehicle ignition is turned on) and/or when a vehicle ends a trip (e.g., when a vehicle ignition is turned off). Dust accumulation may not be a known factor for a vehicle that has sat idle (e.g., in a dusty area such as a gravel parking lot) such that sensor cleaning upon startup of a vehicle may be beneficial. Similarly, to help prevent debris from drying or setting in on a lens of a sensor, the cleaning operation may be performed when a vehicle trip ends to avoid caking of debris on the sensor.

The sensor assemblies described herein are generally positioned on vehicles in a fixed position relative to the vehicle, such that forward-facing sides of the sensor are more likely to be fouled by debris, bugs, dirt, fluid, etc. As such, forward-facing sensors may have different cleaning periods than sensors facing other directions. Further, forward-facing sensor assemblies may employ different nozzles and spray patterns based on their increased likelihood of debris accumulation.

For multi-sensor assembly embodiments, sensor cleaning may be performed independently or collectively. According to some embodiments, a proportioning valve can be used to send a higher volume and/or a higher pressure of fluid to the nozzles spraying a forward facing sensor assembly to bias the cleaning operation toward the forward-facing sensor assembly, thereby counteracting the larger proportion of contaminants experienced by the forward-facing sensor assembly.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A sensor assembly comprising:
a sensor having a sensor lens and a field-of-view through the sensor lens; and
a baffle defining a sensor lens aperture, wherein the field-of-view through the sensor lens is through the sensor lens aperture,
wherein the baffle comprises a series of concentric rings extending away from the sensor lens aperture and increasing in diameter as a distance from the sensor lens aperture increases.

2. The sensor assembly of claim 1, wherein the series of concentric rings defines a viewing angle, wherein the viewing angle corresponds to the field-of-view of the sensor lens.

3. The sensor assembly of claim 1, wherein the series of concentric rings include forward-facing surfaces between surfaces that are substantially parallel to an axis through a center of the sensor lens.

4. The sensor assembly of claim 3, wherein the surfaces that are substantially parallel to the axis through the center of the sensor lens have a surface texture configured to diffuse light.

5. The sensor assembly of claim 1, further comprising an injector, wherein the injector is received within a port of the baffle and configured to direct a spray pattern of cleaning fluid toward the sensor lens.

6. The sensor assembly of claim 5, wherein the injector is controlled by a controller, and wherein the controller commands the injector to spray the sensor lens with cleaning fluid.

7. The sensor assembly of claim 6, wherein the controller is configured to establish a cleaning regimen based, at least in part, on environmental context of the sensor assembly.

8. The sensor assembly of claim 7, wherein the cleaning regimen is further based, at least in part, on at least one of time of travel of a vehicle associated with the sensor assembly or distance of travel of the vehicle associated with the sensor assembly.

9. The sensor assembly of claim 6, further comprising a pneumatic nozzle, wherein the pneumatic nozzle is configured to direct a burst of air to the sensor lens of the sensor assembly.

10. The sensor assembly of claim 9, wherein the pneumatic nozzle is controlled by the controller, and wherein the controller commands the nozzle to direct the burst of air to the sensor lens of the sensor assembly.

11. The sensor assembly of claim 1, further comprising a nozzle, wherein the nozzle is supplied with a cleaning fluid for cleaning of the sensor lens, and wherein the nozzle is configured to direct a spray pattern of the cleaning fluid toward the sensor lens of the sensor.

12. A baffle for a sensor assembly comprising:
a sensor lens aperture for receiving therein a sensor lens of the sensor assembly;
a series of concentric rings extending away from the sensor lens aperture and increasing in diameter as a distance from the sensor lens aperture increases; and
a nozzle defined within the baffle, wherein the nozzle is configured to direct a spray pattern of cleaning fluid toward a sensor lens received in the sensor lens aperture.

13. The baffle of claim 12, wherein the nozzle is supplied with fluid from an injector, wherein the baffle defines a port into which the injector is received.

14. The baffle of claim 12, wherein the series of concentric rings defines a viewing angle, wherein the viewing angle corresponds to a field-of-view of the sensor lens, wherein the series of concentric rings include forward-facing surfaces between surfaces that are substantially parallel to an axis through a center of the sensor lens.

15. The baffle of claim 14, wherein the surfaces that are substantially parallel to the axis through the center of the sensor lens have a matte finish surface texture.

16. A method for protecting and cleaning a lens of a sensor assembly comprising:
surrounding the lens of the sensor assembly with a baffle, wherein the baffle defines a sensor lens aperture, and wherein the baffle comprises a series of concentric rings extending away from the sensor lens aperture and increasing in diameter as a distance from the sensor lens aperture increases.

17. The method of claim 16, further comprising:
cleaning the lens of the sensor assembly with a spray pattern of cleaning fluid, wherein the spray pattern emanates from a nozzle disposed within the baffle.

18. The method of claim 17, further comprising:
controlling the cleaning of the lens of the sensor assembly using a controller, wherein the controller commands the cleaning of the lens.

19. The method of claim 18, further comprising:
establishing a cleaning regimen for the sensor based, at least in part, on environmental context of the sensor assembly.

20. The method of claim 19, wherein the cleaning regimen is further based, at least in part, on at least one of time of travel of a vehicle associated with the sensor assembly or distance of travel of the vehicle associated with the sensor assembly.
